(19) United States
(12) Patent Application Publication
(10) Pub. No.: US 2003/0098578 A1
(43) Pub. Date: May 29, 2003

(54) Expandable pocket for a binder

(76) Inventor: Marc Lyman Moor, Oakwood, OH (US)

Correspondence Address: Michael S. Neustel, 2534 South University Drive, Suite No. 4, Fargo, ND, 58103, US

(21) Appl. No.: 09/990,111

(22) Filed: Nov. 21, 2001

(51) Int. Cl. B42D 3/00

(52) U.S. Cl. 281/31

(57) ABSTRACT

An expandable pocket for a binder for receiving and storing varying thickness of documents. The expandable pocket for a binder includes a panel member secured within a portion of a binder, a first elastic strap attached between a side of the panel member and the binder, and a second elastic strap attached between side of the panel member opposite of the first elastic strap and the binder. The elastic straps allow the panel member to contract and expand depending upon the thickness and size of document to be retained between the panel member and the portion of the binder.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to binder pockets and more specifically it relates to an expandable pocket for a binder for receiving and storing varying thickness of documents.

2. Description of the Prior Art

Pockets within binders have been in use for years. Typically, a pocket is positioned within one of the side portions of the binder for receiving documents such as paper, notebooks and related items. The pocket within a conventional binder is typically comprised of a solid structure with an upper opening for receiving one or more documents.

The main problem with conventional binders and pockets for binders is that they are designed to receive a “fixed” thickness of documents. Individuals utilizing conventional binders are often times limited to the amount of documents that may be easily inserted into the binder pocket. Another problem is that individuals often times will insert too many documents within a pocket of a binder thereby causing the pocket to become damaged thereby reducing the useful life of the binder. A further problem with conventional pockets for binders is that they become deformed by the insertion of too many documents thereby causing the pocket to become enlarged making it difficult to snugly retain documents that have a smaller thickness.

While these devices may be suitable for the particular purpose to which they address, they are not as suitable for receiving and storing varying thickness of documents. Conventional pockets within binders are not suitable for receiving varying sizes and thickness of documents.

In these respects, the expandable pocket for a binder according to the present invention substantially departs from the conventional concepts and designs of the prior art, and in so doing provides an apparatus primarily developed for the purpose of receiving and storing varying thickness of documents.

### SUMMARY OF THE INVENTION

In view of the foregoing disadvantages inherent in the known types of binders now present in the prior art, the present invention provides a new expandable pocket for a binder construction wherein the same can be utilized for receiving and storing varying thickness of documents.

The general purpose of the present invention, which will be described subsequently in greater detail, is to provide a new expandable pocket for a binder that has many of the advantages of the pockets for binders mentioned heretofore and many novel features that result in a new expandable pocket for a binder which is not anticipated, rendered obvious, suggested, or even implied by any of the prior art binders, either alone or in any combination thereof.

To attain this, the present invention generally comprises a panel member secured within a portion of a binder, a first elastic strap attached between a side of the panel member and the binder, and a second elastic strap attached between side of the panel member opposite of the first elastic strap and the binder. The elastic straps allow the panel member to contract and expand depending upon the thickness and size of document to be retained between the panel member and the portion of the binder.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide an expandable pocket for a binder that will overcome the shortcomings of the prior art devices.

A second object is to provide an expandable pocket for a binder for receiving and storing varying thickness of documents.

Another object is to provide an expandable pocket for a binder that may be utilized in various types of binders.

An additional object is to provide an expandable pocket for a binder that is not easily damaged during the insertion of various thickness documents.

A further object is to provide an expandable pocket for a binder that maintains a desirable tension against documents having varying thickness.

Another object is to provide an expandable pocket for a binder that extends the useful life of a binder.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the present invention within a binder.

FIG. 2 is an upper perspective view of the present invention within a binder retaining a document.

FIG. 3 is a magnified upper perspective view of the present invention.

FIG. 4 is a magnified upper perspective view of the present invention retaining a document.

FIG. 5 is a bottom upper perspective view of an alternative embodiment of the present invention.

FIG. 6 is a top upper perspective view of the alternative embodiment of the present invention.

### DESCRIPTION OF THE PREFERRED EMBODIMENT

A. Overview

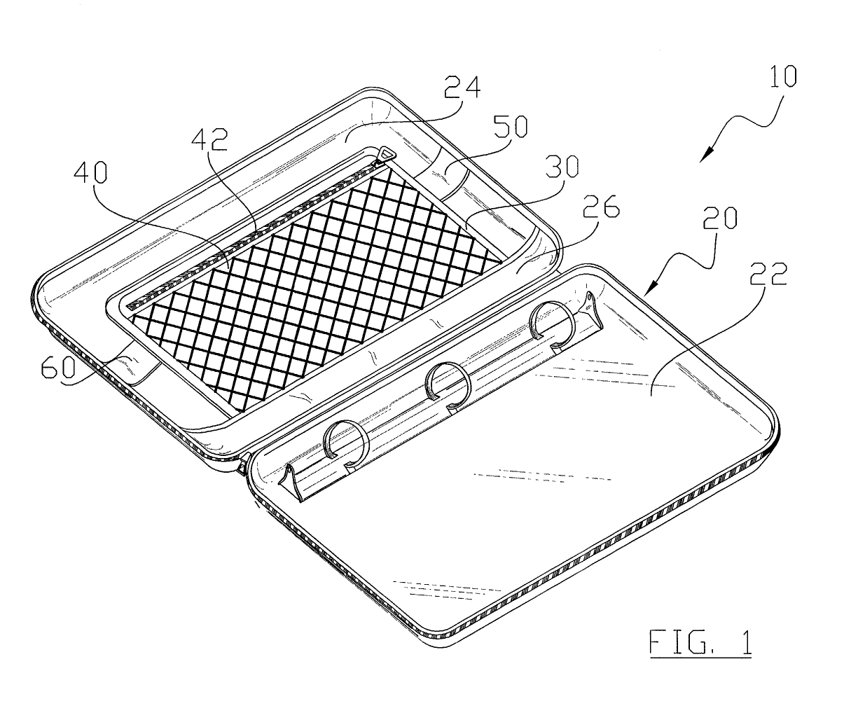

Turning now descriptively to the drawings, in which similar reference characters denote similar elements throughout the several views, FIGS. 1 through 6 illustrate an expandable pocket for a binder 10, which comprises a panel member 30 secured within a second portion 24 of a binder 20, a first elastic strap 50 attached between a side of the panel member 30 and the binder 20, and a second elastic strap 60 attached between side of the panel member 30 opposite of the first elastic strap 50 and the binder 20. The elastic straps allow the panel member 30 to contract and expand depending upon the thickness and size of document 12 to be retained between the panel member 30 and the second portion 24 of the binder 20.

B. Binder

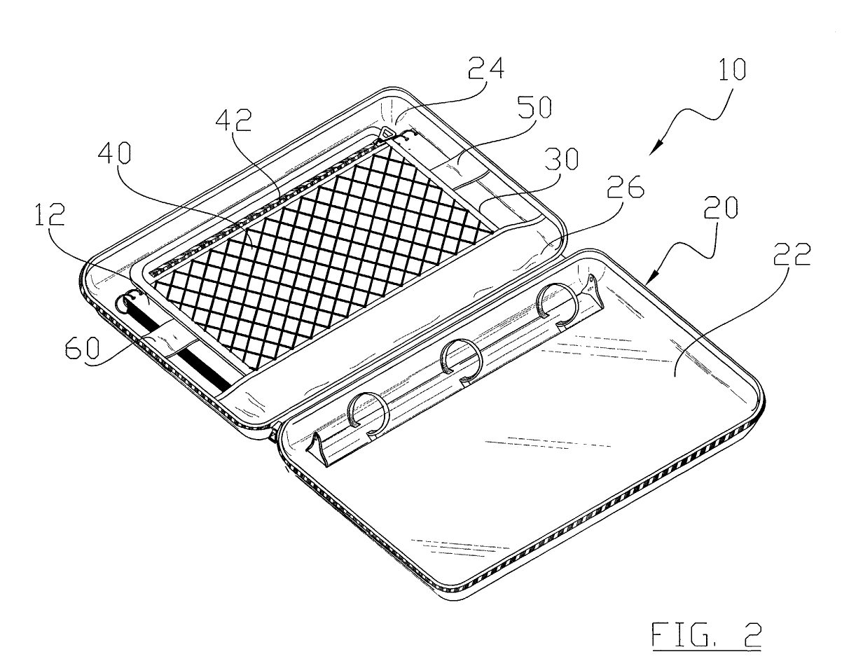

As shown in FIGS. 1 and 2 of the drawings, a binder 20 typically has a first portion 22 and a second portions 24 pivotally attached to one another. The binder 20 has an interior portion and an exterior portion for receiving and storing documents 12 such as paper, notepads and the like as is well known in the art. The first portion 22 and the second portion 24 of the binder 20 may be retained against one another via various conventional fastening means such as but not limited to a securing strap, buttons or zipper 42.

The binder 20 may be comprised of various shapes, sizes, styles, structures and materials as can be appreciated. The interior portion of the binder 20 may have various sizes, shapes and structures as further can be appreciated. The binder 20 shown in FIGS. 1 through 6 of the drawings are for illustration purposes only. It can be appreciated that the present invention may be utilized in different manners and upon different designs of binders.

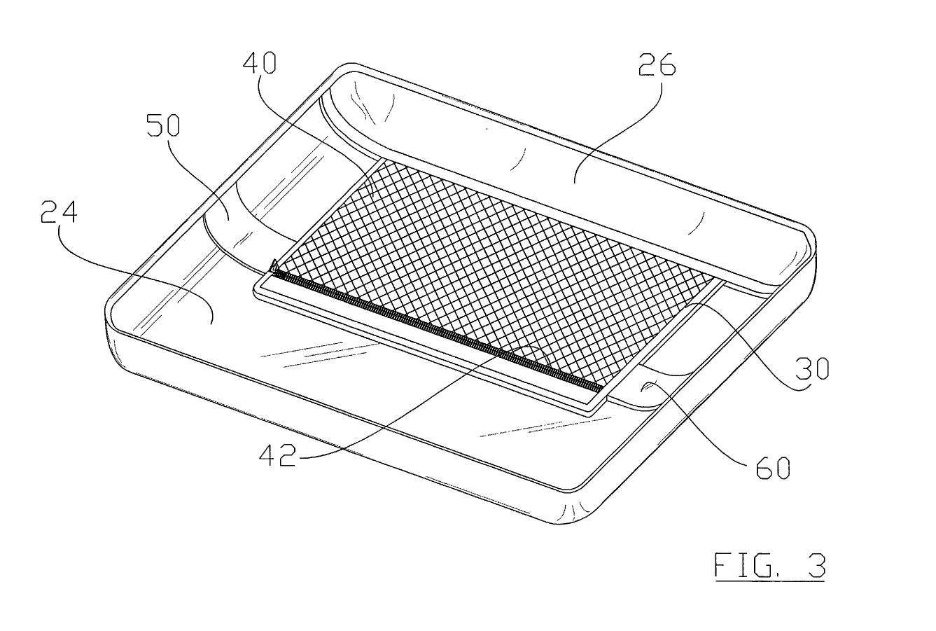

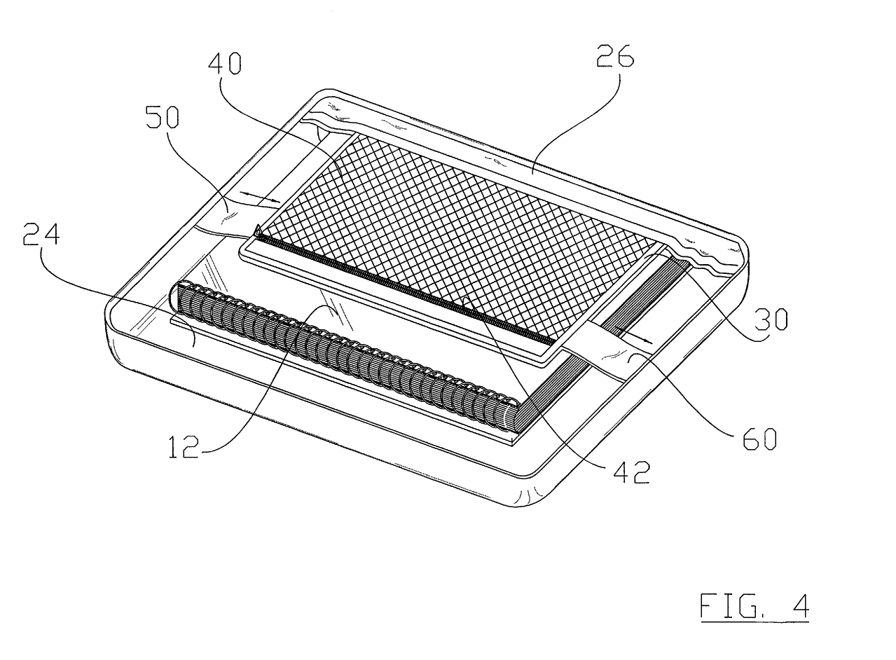

FIGS. 3 and 4 of the drawings illustrate the second portion 24 of the binder 20. The second portion 24 of the binder 20 has an inner edge that is pivotally attached to the first portion 22 of the binder 20 as best shown in FIGS. 1 and 2 of the drawings. The second portion 24 has an outer edge that is opposite of the inner edge. The second portion 24 further includes a first side edge and a second side edge which traverse the outer and inner edges as further shown in FIGS. 1 and 2 of the drawings.

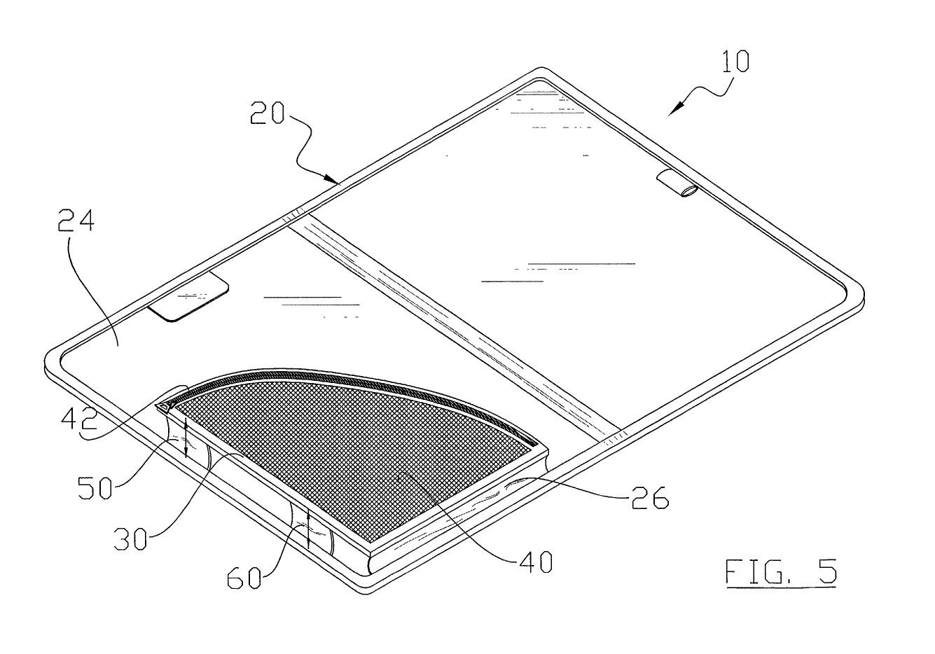

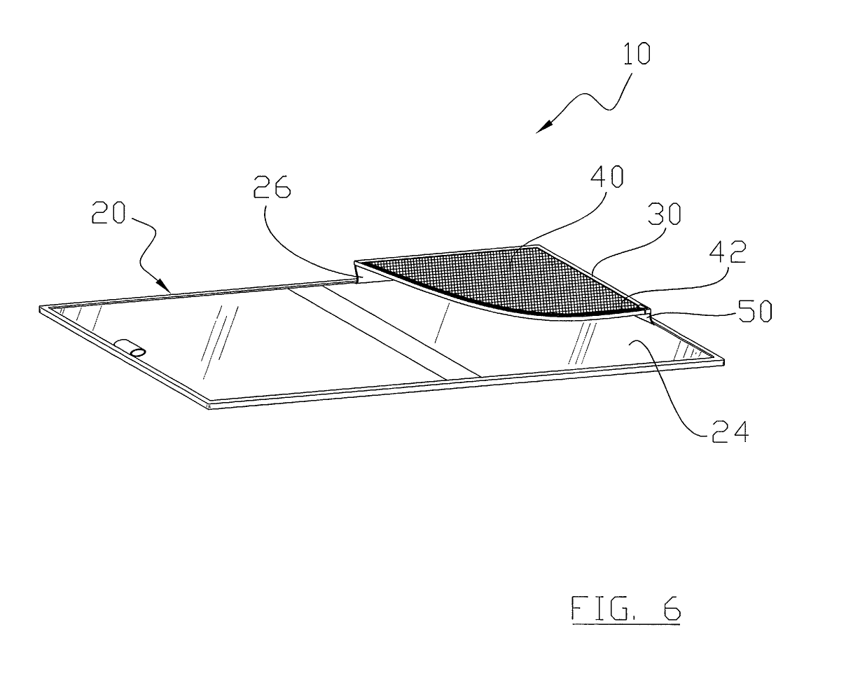

The edges of the first portion 22 and the second portion 24 are preferably curved inwardly to create an interior cavity when closed upon one another as shown in FIGS. 1 and 2 of the drawings. However, the first portion 22 and the second portion 24 may have relatively flat structures as shown in FIGS. 5 and 6 of the drawings.

C. Panel Member

As shown in FIGS. 1 through 4 of the drawings, the panel member 30 is attached to the inner edge of the second portion 24 of the binder 20. It can be appreciated that the panel member 30 may be attached to other edges of the second portion 24 by simply rotating the invention accordingly with respect to the second portion 24. The outer edge of the panel member 30 is not attached to the second portion 24 of the binder 20 thereby allowing for the insertion of documents 12 and the like. The side edges of the panel member 30 are preferably not attached to the second portion 24 except for the elastic straps 50, 60 for allowing a sufficient range of movement for the panel member 30. The panel member 30 may be attached to the interior or exterior portions of the binder 20 as can be appreciated.

The panel member 30 is preferably a rectangular shaped structure, however various other shapes may be utilized for the panel member 30. The panel member 30 may be comprised of a rigid or pliable material and structure. The panel member 30 preferably has a minimum amount of rigidity within for applying relatively consistent tension upon a document 12.

As shown in FIGS. 1 through 4 of the drawings, a cross member 26 may be attached between the inner edge of the second portion 24 of the binder 20 and the panel member 30. The cross member 26 preferably extends along an entire length of the inner edge of the second portion 24 and is attached to the opposing side edges of the second portion 24 as best shown in FIGS. 3 and 4 of the drawings. FIG. 5 illustrates the cross member 26 only being attached to a lower side edge of the binder 20 and not to the inner edge.

The cross member 26 is preferably comprised of a pliable, non-elastic structure and material that forms a lower receiving pocket opposite of the outer edge of the panel member 30. The cross member 26 may be comprised of various types of pliable materials such as but not limited to fabric or plastic. The cross member 26 preferably has a width of at least one inch for easily receiving the lower portion of a document 12.

D. Elastic Straps

FIGS. 1 through 5 illustrate the usage of a plurality of elastic straps 50, 60 attached between the second portion 24 of the binder 20 and the panel member 30. Any number of elastic straps 50, 60 may be utilized within the present invention and the drawings should not limit the number of elastic straps 50, 60 utilized. The elastic straps 50, 60 are comprised of an elastic material that allows for repeated extension and contraction thereof. The elastic material may be comprised of various well-known materials have elastic qualities.

As shown in FIGS. 1 through 4 of the drawings, a first elastic strap 50 is attached to a first side edge of the panel member 30. The opposing end of the first elastic strap 50 is attached to the first side edge of the second portion 24 in a manner traverse to the first side edge of the panel member 30 as shown in FIGS. 1 through 4 of the drawings. The first elastic strap 50 is preferably attached a finite distance away from the inner edge of the second portion 24 for facilitating increased movement of the panel member 30. The first elastic strap 50 is preferably attached a distance at least 50% of the length of the panel member 30 away from the inner edge of the second portion 24.

As shown in FIGS. 1 through 4 of the drawings, a second elastic strap 60 is attached to a second side edge of the panel member 30 opposite of the first elastic strap 50. The opposing end of the second elastic strap 60 is attached to the second side edge of the second portion 24 in a manner traverse to the second side edge of the panel member 30 as shown in FIGS. 1 through 4 of the drawings. The second elastic strap 60 is preferably attached a finite distance away from the inner edge of the second portion 24 for facilitating increased movement of the panel member 30. The second elastic strap 60 is preferably attached a distance at least 50% of the length of the panel member 30 away from the inner edge of the second portion 24. As further shown in FIGS. 1 through 4 of the drawings, the second elastic strap 60 is attached to the panel member 30 at a distance from the inner edge of the second portion 24 equal to the attachment location of the first elastic strap 50.

E. Front Pocket

As shown in FIGS. 1 through 6 of the drawings, a front pocket 40 is preferably attached to the outer surface of the panel member 30 for storing additional items. The front pocket 40 may be comprised of various types of materials and structures such as but not limited to netting. The front pocket 40 has an opening for inserting documents 12 and related items within. A closure, such as a zipper 42, is preferably attached about the opening of the front pocket 40 for selectively retaining the items within.

F. Alternative Embodiment

As shown in FIGS. 5 and 6 of the drawings, the alternative embodiment of the present invention is comprised of a structure similar to the main embodiment discussed above. The alternative embodiment is comprised of a panel member 30 attached either directly to a lower edge of the second portion 24 or to a cross member 26 that is attached to the lower edge thereof. In the alternative embodiment, the elastic straps 50, 60 are attached to only one side of the panel member 30 thereby allowing insertion of documents 12 within the upper and opposing side portion of the panel member 30. The panel member 30 may have a curved outer edge or various other shapes for facilitating easy insertion of documents 12 within as shown in FIGS. 5 and 6 of the drawings.

G. Usage of Invention

As shown in FIGS. 1 and 3 of the drawings, when there are no documents 12 retained between the panel member 30 and the second portion 24 the elastic straps 50, 60 are in a generally relaxed position. The relaxed position of the elastic straps 50, 60 may or may not have an amount of tension upon the elastic straps 50, 60. The inventor has found that is advantageous to maintain a slight amount of tension upon the elastic straps 50, 60 in the relaxed position thereby allowing for tension to be applied to documents 12 of slight thickness. Varying amounts of tension may be applied to the panel member 30 by the elastic straps in the relaxed position as can be appreciated.

To insert documents 12 within the present invention, the individual typically grasps the outer edge of the panel member 30 with one hand and pulls the panel member 30 away from the second portion 24 of the binder 20 to expand the opening defined between the panel member 30 and the second portion 24. The elastic straps 50, 60 extend in length to accommodate the new position of the panel member 30 as shown in FIG. 4 of the drawings. The user then inserts the documents 12 between the panel member 30 and the second portion 24 of the binder 20 as shown FIGS. 2 and 4 of the drawings. The lower portion of the documents 12 are retained by the cross member 26 thereby preventing damage to the documents 12. The user then releases the panel member 30 thereby allowing the panel member 30 to contract upon and apply tension upon the document 12 thereby snugly retaining the document 12 within the binder 20. To remove the document 12 from between the panel member 30 and the second portion 24, the user may simply grasp the document 12 directly or first pull the panel member 30 away from the second portion 24.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed to be within the expertise of those skilled in the art, and all equivalent structural variations and relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

Index of Elements for Expandable Pocket For A Binder

□ ENVIRONMENTAL ELEMENTS
□
□
□
□
□
□
□
□
□
□ 10. Expandable Pocket For A Binder
□ 11.
□ 12. Document
□ 13.
□ 14.
□ 15.
□ 16.
□ 17.
□ 18.
□ 19.
□ 20. Binder
□ 21.
□ 22. First Portion
□ 23.
□ 24. Second Portion
□ 25.
□ 26. Cross Member
□ 27.
□ 28.
□ 29.
□ 30. Panel Member
□ 31.
□ 32.
□ 33.
□ 34.
□ 35.
□ 36.
□ 37.
□ 38.
□ 39.
□ 40. Front Pocket
□ 41.
□ 42. Zipper
□ 43.
□ 44.
□ 45.
□ 46.
□ 47.
□ 48.
□ 49.
□ 50. First Elastic Strap
□ 51.
□ 52.
□ 53.
□ 54.
□ 55.
□ 56.
□ 57.
□ 58.
□ 59.
□ 60. Second Elastic Strap
□ 61.
□ 62.
□ 63.
□ 64.
□ 65.
□ 66.
□ 67.
□ 68.
□ 69.
□ 70.
□ 71.
□ 72.
□ 73.
□ 74.
□ 75.
□ 76.
□ 77.
□ 78.
□ 79.

I claim:

1. An expandable pocket for a binder having a first portion and a second portion, comprising:
a panel member having a first edge, a second edge, a first side edge, and a second side edge, wherein said first edge of said panel member is attached to a first edge of said second portion of said binder defining a space between for receiving documents;
at least one first elastic strap attached between said first side edge of said panel member and a first side edge of said second portion of said binder; and
at least one second elastic strap attached between said second side edge of said panel member and a second side edge of said second portion of said binder.

2. The expandable pocket for a binder of claim 1, wherein said first elastic strap is attached opposite of said second elastic strap.

3. The expandable pocket for a binder of claim 1, wherein said first elastic strap and said second elastic strap are attached closer to said second edge of said panel member than to said first edge of said panel member.

4. The expandable pocket for a binder of claim 1, wherein said panel member is comprised of a rigid structure.

5. The expandable pocket for a binder of claim 1, wherein said panel member is comprised of a semi-rigid structure.

6. The expandable pocket for a binder of claim 1, wherein said panel member is comprised of a pliable structure.

7. The expandable pocket for a binder of claim 1, including a front pocket attached to an outer surface of said panel member.

8. The expandable pocket for a binder of claim 7, wherein said front pocket is comprised of a netting structure.

9. The expandable pocket for a binder of claim 1, wherein said panel member is positioned within an interior portion of said second portion.

10. The expandable pocket for a binder of claim 1, including a cross member attached between said first edge of said second portion and said first edge of said panel member, wherein said cross member forms a pocket adjacent said first edge of said second portion by extending along an entire length of said second portion and attached to opposing sides of said second portion.

11. An expandable pocket for a binder having a first portion and a second portion, comprising:
a panel member having a first edge, a second edge, a first side edge, and a second side edge, wherein said first edge of said panel member is attached to a first edge of said second portion of said binder defining a space between for receiving documents; and
at least one elastic strap attached between said first side edge of said panel member and a first side edge of said second portion of said binder.

12. The expandable pocket for a binder of claim 11, wherein said at least one elastic strap is comprised of a plurality of elastic straps.

13. The expandable pocket for a binder of claim 11, wherein said at least one elastic strap is comprised of a first elastic strap attached to said first side edge of said panel member adjacent said second edge, and a second elastic strap attached to said first side edge of said panel member adjacent said first edge.

14. The expandable pocket for a binder of claim 11, wherein said panel member is comprised of a rigid structure.

15. The expandable pocket for a binder of claim 11, wherein said panel member is comprised of a semi-rigid structure.

16. The expandable pocket for a binder of claim 11, wherein said panel member is comprised of a pliable structure.

17. The expandable pocket for a binder of claim 11, including a front pocket attached to an outer surface of said panel member.

18. The expandable pocket for a binder of claim 17, wherein said front pocket is comprised of a netting structure.

19. The expandable pocket for a binder of claim 11, wherein said panel member is positioned within an interior portion of said second portion.

20. The expandable pocket for a binder of claim 11, including a cross member attached between said first edge of said second portion and said first edge of said panel member, wherein said cross member forms a pocket adjacent said first edge of said second portion by extending along an entire length of said second portion and attached to opposing sides of said second portion.
